(19) United States
(12) Patent Application Publication
(10) Pub. No.: US 2022/0087779 A1
(43) Pub. Date: Mar. 24, 2022

(54) RETENTION DEVICE COMPRISING A RETENTION APPARATUS AND POSITIONING CLIPS, AND METHOD FOR PRODUCING SUCH A RETENTION DEVICE

(71) Applicant: BIOTECH DENTAL, Salon De Provence (FR)

(72) Inventors: Dominique SIREIX, Bogeve (FR); Christophe SIREIX, Bogeve (FR)

(21) Appl. No.: 17/424,637

(22) PCT Filed: Jan. 22, 2020
(86) PCT No.: PCT/FR2020/050087

§ 371 Date: Jul. 21, 2021

(30) Foreign Application Priority Data
Jan. 23, 2019 (FR) 1900592

(51) Int. Cl. A61C 7/08; A61C 7/00; B33Y 80/00; B33Y 50/00

(52) U.S. Cl. CPC A61C 7/08; B33Y 50/00; B33Y 80/00; A61C 7/002

(57) ABSTRACT

Disclosed is a retention device including at least one retention apparatus, designed to be bonded on a portion of a dental arch, and at least two clips, positioned apart from one another; each clip being a rigid hook and rigidly attached to the retention apparatus, and configured to fasten to the dental arch. Also disclosed is a method for producing such a retention device.

### BACKGROUND OF THE INVENTION

### Field of the Invention

The present invention relates to a retention device including a retention apparatus, as well as a method for producing a retention device of this type.

### Description of the Related Art

In the field of orthodonture, an active treatment plan, i.e. for corrected poor posture of the teeth for a functional or esthetic reason, is established by the use of different means, such as for example:
fixed apparatus, which are bonded on the teeth by rings (of metal, ceramic or elastomer) and which are linked to one another by a cable or metal rod for example; or
removable, often transparent apparatus, in the form of a gutter, made of plastic material.

Once the active orthodontic apparatus is removed, it is necessary to retain the acquired results using a retention apparatus, on pain of recurrence of the initial anomaly or the appearance of a new pathology.

This retention apparatus can also be fixed or removable.

If it is removable, it will be worn according to a prescription, permanently (i.e. 24 h/24), or part of the time (for example 15h/24 or at night or 8 h/24). The wearing period is a minimum of one year. It is sometimes necessary to keep it for 5 years, 10 years or lifelong. In this case, it consists for example of a simple palatal plate, or a Hawley plate, or activators, or gutters, i.e. a sort of tooth protector which can be made of soft resin or of transparent polymer for example.

If it is fixed, it often consists of a retention apparatus polymerized or bonded in the mouth of an individual, which stabilizes the results acquired. In this case it can consist, for example, of a twisted metal wire bonded directly to each of the teeth that it covers, or of a metal wire bonded to two metal facets themselves bonded directly to two teeth, canines for example, or even a lingual to bar arc, i.e. a metal wire directly welded to canine or pre-molar rings.

In addition, a retention apparatus for an adult is strictly individualized.

However, retention apparatus of this type have several limits, for example:

Those which are of metal have a grey, dull color which is eventually transmitted to the teeth and which affects their iridescent appearance.

Metallic retainers are too rigid and generate for example phenomena of separation, and/or immobilization of teeth which induces bone loss and potentially, over the long term, loss of teeth.

Metal wires can scratch teeth and/or induce caries and/or risks of cracking affecting their resilience.

Those which are polymerized in the mouth of an individual require substantial equipment specific to the practitioner. Moreover, polymerization in the mouth is difficult to monitor. Very often the layers are too thick to allow good polymerization. Polymerization under the fiber is very difficult, even impossible in certain cases. Polishing is complicated. The thickness of the retention apparatus is difficult, even impossible to monitor. Material is mixed in between the teeth, which is difficult, even impossible, to clean up.

### SUMMARY OF THE INVENTION

The object of the present invention seeks to improve at least in part the aforementioned disadvantages, also leading to other advantages.

To this end, according to a first aspect, a retention device is proposed including at least one retention apparatus configured to be bonded on a portion of a dental arch.

According to the invention, the retention device also includes at least two clips, positioned apart from one another, each clip being a rigid hook and rigidly attached to the retention apparatus, and configured to fasten to the dental arch.

Such a retention device of the “fixed” type (because it will then be fixed in the mouth of an individual), previously produced, is thus very easy to put in place to be subsequently bonded on the teeth of an individual, i.e. on a portion of the dental arch.

The presence of at least two clips allows precise positioning of the retention device on the portion of the portion of the dental arch prior to bonding the retention device on the corresponding teeth.

A retention device of this type is thus very simple and allows avoiding using other tools or elements for the placement of the retention apparatus.

Moreover, the relative flexibility of the material of the retention apparatus allows in particular producing a single-piece retainer, for example from premolar to premolar, which would be impossible to produce of metal because a retention apparatus of this type would induce excessive stresses on the teeth.

A retention device of this type is also very discreet, even invisible, and it is both sufficiently rigid so as to restrain the teeth but with a relative flexivility, which allows in particular to make it less traumatizing for the teeth or the tissues and/or less constraining for the wearer.

Preferably, the retention device has an average thickness of at least 0.3 mm, for example comprised between 0.5 mm and 0.9 mm, for example approximately 0.8 mm.

The thickness of the retention apparatus is for example at the maximum equal to 3 mm and at a minimum equal to 0.3 mm.

Here the retention apparatus is preferably a ribbon.

Here a ribbon designates a bar of which one dimension, for example a thickness e, amongst a height h, a length L and a thickness e of the apparatus, is much less than the two other dimensions, for example the length L and the height h. Thus here the length L corresponds to the dimension of the apparatus along the dental arch and corresponds for example to the number of teeth covered by the apparatus, while the height h corresponds to a transverse dimension along the height of a tooth; a thickness e thus corresponds to the third dimension. By comparison, an apparatus in the form of a wire would have a height substantially equal to its thickness.

In one particular exemplary embodiment, the height h is also much larger than the thickness e.

The retention apparatus is thus configured to cover a greater surface of each tooth along its height, which will allow a more stable retention of the tooth. In an advantageous exemplary embodiment, the retention apparatus has a shape corresponding to a set of back, also called posterior, faces of the teeth of the portion of the dental arch which it is configured to cover.

It is thus possible to minimize a possible discomfort which could be occasioned for an individual by the presence of an apparatus of this type in the mouth.

In one implementation example, the retention apparatus is configured to cover 2, or 4, or 6 or even 8 teeth, or even more depending on the case; if for example it involves covering a sector from one canine to another canine, or even from one premolar to another premolar, in the same dental arch.

The retention device includes at least two clips to ensure stability of the retention device positioned on the dental arch.

The retention device can, however, include three clips or more.

According to a preferred exemplary embodiment, each clip extends at a maximum until the mid-height of the retention device. A clip length of this type allows facilitating the subsequent positioning of the retention device on a dental arch.

According to another preferred exemplary embodiment, at least one of the clips is configured to anchor itself on an interface between two consecutive teeth.

For example, for a retention device including three clips, one of the three clips can be located between the two central incisors and the two other clips can be located between a lateral incisor and the adjacent canine.

Such a positioning of the clips allows insuring a more stable balance of the retention device positioned on a dental arch.

In a preferred exemplary embodiment, the retention device includes at least one breakable rupture primer located at an intersection between one of the clips and the retention apparatus in order to facilitate a removal of the clip.

A breakable rupture primer of this type is for example a notch and/or a narrowing of the cross section of the clip.

According to an exemplary embodiment, at least the retention device is produced in a composite polymer material.

For example, the composite polymer material includes a crosslinked amorphous composite polymer material.

In a particular example, the composite polymer material includes a crosslinked amorphous polymer material with a methacrylate base.

Here the methacrylate is a mixture of liquid monomers, the crosslinking of which is initiated by a peroxide. The hardening of the monomer mixture, depending on the concentration of peroxide, occurs either at ambient temperature or at low temperature, or even at a negative temperature. Crosslinked mixtures are characterized particularly by:

very fast commissioning;

possible hardening at low temperature, even at a negative temperature;

good mechanical and chemical resistance;

more or less flexibility;

strong adhesion to numerous media.

One advantageous material is for example the material marketed under the reference Bredent HIPC® (High Impact Polymer Composite).

Althrough a material of this type was known for other applications, it has proven particularly advantageous for the production of the bar type retention apparatus, in particular due to its color near that of the enamel of teeth and due to its mechanical properties, and in particular for bending loads.

In one case of producing the retention apparatus by three-dimensional printing, materials that are advantageous to use are for example the material marketed under the reference “NextDent C&B38 ® or the material marketed under the reference “NextDent C&B MFH (Micro Filled Hybrid)”®, both from Nextdent®.

Also proposed, according to another aspect, is a method for producing a retention device including all or part of the features previously described.

According to an advantageous example, the method includes a step of machining a wafer of material configured to produce at least a portion of the retention device.

In a preferred implementation example, machining is carried out in a wafer of crosslinked amorphous polymer composite material, as previously described. A material of this type is for example marketed under the reference Bredent HIPC® (High Impact Polymer Composite)).

In a preferred implementation example, the machining is carried out with a so-called “laboratory” machine, like that marketed under the designation Roland DWX 510® or IMES-ICORE CORITEC 350i®.

According to another advantageous example, the method includes a step of three-dimensional printing of at least a portion of the retention device.

Machining and three-dimensional printing can be combined, depending on the shape to be given to the retention device for example.

For example, at the end of an orthodontic treatment, the method includes a step of taking an imprint of at least a portion of a dental arch of an individual. At least one digital file allowing 3D modeling is then obtained.

For example, the step of taking an imprint includes taking a physical imprint of at least a portion of a dental arch of an individual to obtain a mold.

The method can then include a step of pouring plaster into the mold to obtain a plaster model of the portion of the arch, also called a matrix.

Then, for example, the step of taking an impring can comprise a step of digital scanning of the matrix.

The digital file is for example extracted by means of a three-dimensional scan for example (for example of the Imetrics® type).

According to another advantageous possibility, the step of taking an imprint includes a step of taking an imprint of at least a portion of a dental arch of an individual directly in the mouth thanks to an intrabuccal scan, for example using a CONDOR® camera.

The matrix representing at least one portion of the dental arch is also possibly produced by 3D printing. For example, the matrix can be printed in resin, for example with a Stratasys Eden 50® printer.

If necessary, the 3D file of the print of the portion of the dental arch thus obtained (following the scan of a matrix or directly in the mouth), i.e. the digital model of the portion of the dental arch, is taken up in a program (such as Dental-Wings® for example).

The orientation of the arch is possibly optimized in order to reduce undercuts on the vestibular faces of the teeth relative to a theoretical vertical axis; in other words, this operation allows “opening” the internal faces of the teeth, in particular where an retention apparatus according to one exemplary embodiment of the invention will be positioned.

The method can then include a step of modeling the retention device; this step thus supplies a digital model of the retention device.

To this end, the method includes for example a step of modeling the retention apparatus as described previously depending on the digital model of the portion of the dental arch, the step thus supplying a digital model of the retention apparatus.

For example, the step of modeling the retention apparatus includes a step of identifying the geometries of the posterior faces of the teeth, i.e. toward the tongue, on which the retention apparatus is to be placed.

For example, the step of modeling the retention apparatus includes a step of defining a thickness of the retaining apparatus.

This thickness can vary, however, according to need.

Then, the method includes for example a step of modeling the clips, depending on the digital model of the portion of the dental arch and on the digital model of the retention apparatus.

The retention device can then be produced.

For the production of at least one retention device, a CAD file, for example a file in the STL format, having at least one model of the retention device as described previously, and preferably several, is transferred, for example to a machining preparation program, for example the program Work-NC®, and/or for three-dimensional printing.

One orientation of the model of the retention device is possibly arranged so as to propose the lingual or palatal face without undercuts relative to a drive axis of a milling cutter.

An embodiment of this type is advantageous because there is no discontinuity over the geometry of the retention apparatus, which can be machined, or printed in a single operation for example without turning over the wafer of material in which the machining is accomplished.

Optionally, the method can include a step of adjusting the clips while positioning the retention device on the matrix.

According to an advantageous option, the method also includes a step of polishing the retention apparatus thus obtained.

The polishing step can for example include a step of sandblasting a face of the retention apparatus configured to be bonded on the teeth in order to increase the roughness of this face and therefore the adhesion of the apparatus to the teeth.

According to an interesting option, the method also comprises a step of cleaning the retention apparatus.

The cleaning step is for example implemented by an ultrasonic bath.

It is then ready to be located in the mouth of an individual.

Once the retention apparatus is bonded, it is then possible to withdraw the clips.

One advantageous adhesive is for example an adhesive marketed under the designation “Panavia V5 KURARAY.”

The adhesive is then photo-polymerized.

The withdrawal of the clips can be carried out by simple breakable action or for example by milling, directly in the mouth of the individual.

A retention apparatus of this type can then be retained temporarily or for life.

The mimicry is very good due to the natural color of the material used and the small thickness of the retention apparatus which further allows it to adapt to the color of the teeth by transparency.

Moreover, the material can have different shades, which allows it to better adjust to that of the teeth of the individual for whom the retention apparatus is intended.

A retention apparatus of this type is thus more esthetic, resistance and comfortable and is much better adjusted to a dental arch.

### BRIEF DESCRIPTION OF THE DRAWINGS

The invention, according to one exemplary embodiment, will be better understood and its advantages will be better revealed upon reading the detailed description that follows, given by way of indication and in no way limiting, with reference to the appended drawings in which:

FIG. 1 shows a digital model of a dental arch;

FIG. 2 illustrates an extract of the geometries of the posterior faces of the teeth on which a retention apparatus is to be placed;

FIG. 3 shows a digital model of a retention device according to an exemplary embodiment of the invention;

FIG. 4 shows schematically a positioning of the clips on a dental arch;

FIG. 5 illustrates an exemplary embodiment of a retention device according to the invention, including a retention apparatus and three clips;

FIG. 6 illustrates an anterior view of the retention device of FIG. 5;

FIG. 7 shows an example of positioning of the retention device of FIG. 5 on a dental arch;

FIG. 8 illustrates, in section view, placement of the retention device for a positioning as illustrated in FIG. 7;

FIG. 9 shows a section view of FIG. 7; and

FIG. 10 illustrates schematically the retention apparatus derived from the retention device shown in FIG. 5 on a dental arch as illustrated in FIG. 7.

### DESCRIPTION OF THE PREFERRED EMBODIMENTS

Identical elements shown in the aforementioned figures are identified by identical numerical references.

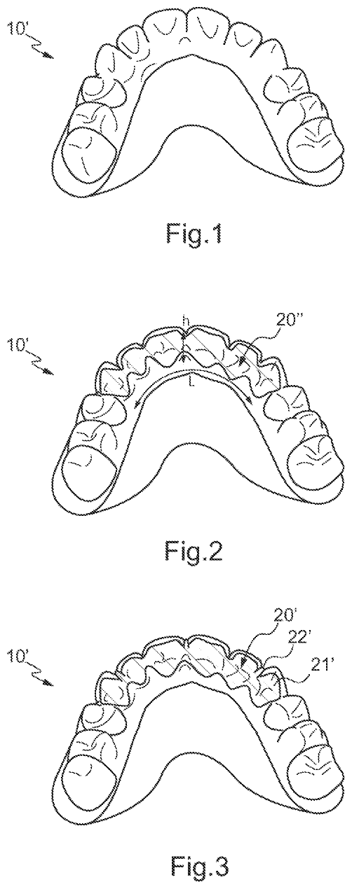

FIG. 1 show a three-dimensional digital model of a dental arch 10′.

A three-dimensional digital model of a dental arch 10′ of this type is for example produced by means of an intrabuccal scan, for example by means of a CONDOR® camera.

The digital file of the imprint thus obtained is possibly taken up in a program, for example the Dental-Wings® program.

A modeling of a retention apparatus 20 can then be performed.

It is then a matter of defining a geometry of the retention device, i.e. of the retention apparatus and of the clips.

To this end, a step of modeling the retention apparatus includes a step of identifying the geometries of the posterior faces of the teeth on which the retention apparatus is to be placed.

In FIG. 2, this step appears in the definition of the hashed surface 20″, which serves to define a contour of the retention apparatus.

The method then include s a step of defining the thickness of the retention apparatus.

This thickness (“e,” indicated in FIG. 8 for example) can be constant for the retention apparatus, but is is preferably variable to better adapt the retention apparatus to the shape of the dental arch, for better comfort of the wearer for example, and/or depending on the forces that the retention apparatus must tolerate.

Thus, the average thickness is for example comprised between 0.5 mm and 0.9 mm, and at all points, the thickness is preferably at least equal to 0.3 mm and at most equal to 3 mm.

The thickness e being considered very small relative to a height h (defined according to the height of the teeth) and a length L (defined according to the number of teeth covered by the retention apparatus) of the retention apparatus, the retention apparatus being considered here to be a ribbon.

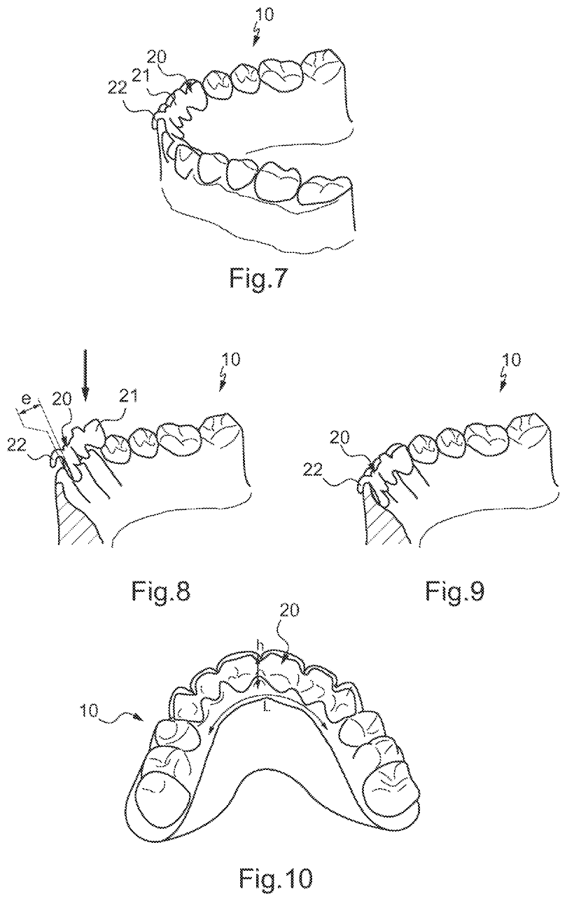

The retention apparatus is configured here to cover 6 teeth; for example, this involves covering a sector from one canine to the other canine of the same dental arch, as illustrated in FIGS. 2 to 7.

The step of modeling the retention device also includes a step of modeling the clips, shown for example in FIG. 3.

Here, the device includes three clips.

The clips are modeled to be positioned at an interface between two consecutive teeth. Thus, in the present exemplary embodiment, two clips are located between one incisor and the adjacent canine, and one clip is positioned between the two central incisors.

Their geometry is defined according to the shape of the dental arch.

The geometry of the clips is adapted and templated to that of the teeth so as to generate only an intimate contact.

Thus the absence of stress generated by the clips allows the retention device to be able to be applied perfectly to the faces of the teeth and to be able to monitor their passivity.

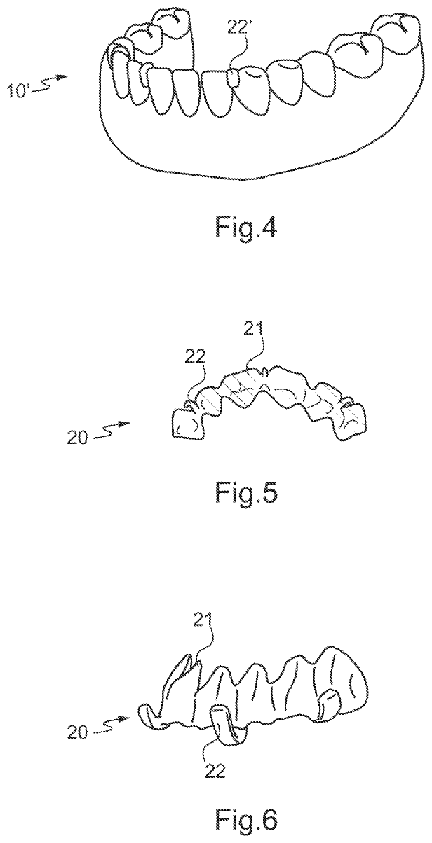

As shown in FIG. 4, each clip preferably extends at a maximum until the equator of the outer face of the teeth to facilitate the positioning of the device on a dental arch.

For example, the length of the clips is configured to ensure sufficient stability to the retention device and avoid a tilting phenomenon. The length of a clip is generally sufficient when it arrives at the level of half the height of the retention apparatus.

Moreover, the clips are configured so that a retention force allows intimate contact between the retention device and the dental arch in order not to generate the tilting phenomenon, i.e. the clips are preferably not exerting stress on the teeth so as not to induce a force which would hamper the positioning of the device and a bonding of the retention apparatus on the back faces of the teeth.

The method also includes a step of defining a breakable rupture primer at an intersection between one of the clips, preferably each of the clips, and the retention apparatus in order to facilitate the subsequent removal of the clip.

A breakable rupture primer of this type is for example a notch and/or a narrowing of the cross section of the clip.

FIG. 3 shows a digital model of a retention device 20′ according to an exemplary embodiment of the invention, including a digital model of the retention apparatus 21′ and a digital model of the clips 22′ (three in number).

FIGS. 5 and 6 show by way of illustration a retention device 20 obtained from the digital model of a retention device 20′ of FIG. 3 for example.

The retention device 20 includes a retention apparatus 21 and clips 22, three clips here.

For producing at least one retention device 20 as described above, a CAD file, for example a file in the STL format, having at least one retention device 20 and preferably more, is transferred for example to a machining preparation program, for example the program Work-NC®, and/or a three-dimensional printing program.

Production by machining and/or by three-dimensional printing is advantageous because there can thus be no discontinuity in the geometry of the retention apparatus and even of the retention device.

In a preferred implementation example, the machining is carried out in a wafer of crosslinked amorphous polymer composite. A material of this type is for example marketed under the reference Bredent HIPC® (High Impact Polymer Composite).

For example, machining is carried out with a so-called “laboratory” machine, such as those marketed under the designation Roland DWX 510® or IMES-ICORE CORITEC 350i®, for example.

The retention apparatus 20 can also be at least in part produced by three-dimensional printing.

It is thus possible to produce several retention devices together, each retention device being specific for a different dental arch.

In one exemplary embodiment, the retention apparatus 20 thus produced is then polished and cleaned.

The placement of the retention device 20 is typically accomplished vertically, as illustrated in FIG. 8, without forcing, without deformation of the retention device, while taking into account a natural undercut of the portion of the dental arch considered, on the vestibular and palatal or lingual face.

For example, the adhesive is applied to the teeth and/or the anterior face of the retention apparatus 21.

An adhesive of this type is for example marketed under the designation Panavia V5 KURARAY®.

The adhesive is then photo-polymerized.

It is then possible to withdraw the clips, for example by simple breakable action or for example by milling, directly in the mouth of the individual.

By way of illustration, FIG. 10 shows the retention apparatus 21, in place on a dental arch 10, which then corresponds to the digital model of a dental arch 10′ illustrated in FIGS. 1 to 4.

1. A retention device including at least one retention apparatus configured to be bonded on a portion of a dental arch, wherein the retention apparatus is configured to cover at least two teeth, the retention device further comprising at least two clips, positioned apart from one another, each clip being a rigid hook and rigidly attached to the retention apparatus, and configured to fasten to the dental arch.

2. The retention device according to claim 1, wherein the retention apparatus has an average thickness of at least 0.3 mm.

3. The retention device according to claim 1, wherein the retention apparatus is a ribbon and has a shape corresponding to a set of back faces, also called posterior faces, of the teeth of the portion of the dental arch which the retention device is configured to cover.

4. The retention device according to claim 1, further comprising at least one breakable rupture primer located at an intersection between one of the clips and the retention apparatus in order to facilitate a removal of the clip.

5. The retention device according to claim 1, wherein at least the retention apparatus is produced in a composite polymer material including an amorphous crosslinked polymer composite material.

6. A method for producing a retention device according to claim 1 including:
modeling the retention device supplying a model of the retention device, the step including:
modeling the retention apparatus depending on a digital model of the portion of the dental arch supplying a digital model of the retention apparatus, and
modeling clips depending on the digital model of the portion of the dental arch and on the digital model of the retention apparatus
machining a wafer of material configured to produce at least a portion of the retention device and/or a step of three-dimensional printing of at least a portion of the retention device depending on the model of the retention device supplied by the step of modeling the retention device.

7. The retention device according to claim 1, wherein the retention apparatus has an average thickness of between 0.5 mm and 0.9 mm.

8. The retention device according to claim 1, wherein the retention apparatus has an average thickness of approximately 0.8 mm.

9. The retention device according to claim 2, wherein the retention apparatus is a ribbon and has a shape corresponding to a set of back faces, also called posterior faces, of the teeth of the portion of the dental arch which the retention device is configured to cover.

10. The retention device according to claim 2, further comprising at least one breakable rupture primer located at an intersection between one of the clips and the retention apparatus in order to facilitate a removal of the clip.

11. The retention device according to claim 3, further comprising at least one breakable rupture primer located at an intersection between one of the clips and the retention apparatus in order to facilitate a removal of the clip.

12. The retention device according to claim 2, wherein at least the retention apparatus is produced in a composite polymer material including an amorphous crosslinked polymer composite material.

13. The retention device according to claim 3, wherein at least the retention apparatus is produced in a composite polymer material including an amorphous crosslinked polymer composite material.

14. The retention device according to claim 4, wherein at least the retention apparatus is produced in a composite polymer material including an amorphous crosslinked polymer composite material.

15. A method for producing a retention device according to claim 2 including:
modeling the retention device supplying a model of the retention device, the step including:
modeling the retention apparatus depending on a digital model of the portion of the dental arch supplying a digital model of the retention apparatus, and
modeling clips depending on the digital model of the portion of the dental arch and on the digital model of the retention apparatus
machining a wafer of material configured to produce at least a portion of the retention device and/or a step of three-dimensional printing of at least a portion of the retention device depending on the model of the retention device supplied by the step of modeling the retention device.

16. A method for producing a retention device according to claim 3 including:
modeling the retention device supplying a model of the retention device, the step including:
modeling the retention apparatus depending on a digital model of the portion of the dental arch supplying a digital model of the retention apparatus, and
modeling clips depending on the digital model of the portion of the dental arch and on the digital model of the retention apparatus
machining a wafer of material configured to produce at least a portion of the retention device and/or a step of three-dimensional printing of at least a portion of the retention device depending on the model of the retention device supplied by the step of modeling the retention device.

17. A method for producing a retention device according to claim 4 including:
modeling the retention device supplying a model of the retention device, the step including:
modeling the retention apparatus depending on a digital model of the portion of the dental arch supplying a digital model of the retention apparatus, and
modeling clips depending on the digital model of the portion of the dental arch and on the digital model of the retention apparatus
machining a wafer of material configured to produce at least a portion of the retention device and/or a step of three-dimensional printing of at least a portion of the retention device depending on the model of the retention device supplied by the step of modeling the retention device.

18. A method for producing a retention device according to claim 5 including:
modeling the retention device supplying a model of the retention device, the step including:
modeling the retention apparatus depending on a digital model of the portion of the dental arch supplying a digital model of the retention apparatus, and
modeling clips depending on the digital model of the portion of the dental arch and on the digital model of the retention apparatus
machining a wafer of material configured to produce at least a portion of the retention device and/or a step of three-dimensional printing of at least a portion of the retention device depending on the model of the retention device supplied by the step of modeling the retention device.

19. The retention device according to claim 7, wherein the retention apparatus is a ribbon and has a shape corresponding to a set of back faces, also called posterior faces, of the teeth of the portion of the dental arch which the retention device is configured to cover.

20. The retention device according to claim 8, wherein the retention apparatus is a ribbon and has a shape corresponding to a set of back faces, also called posterior faces, of the teeth of the portion of the dental arch which the retention device is configured to cover.
